(19) United States
(12) Patent Application Publication
(10) Pub. No.: US 2024/0348131 A1
(43) Pub. Date: Oct. 17, 2024

(54) Assembly for an Electric Machine of a Motor Vehicle, Method and Motor Vehicle

(71) Applicant: Bayerische Motoren Werke Aktiengesellschaft, Muenchen (DE)

(72) Inventors: Fabian CLAUSSEN, Muenchen (DE); Maximilian STOEGER, Baldham (DE)

(21) Appl. No.: 18/683,317

(22) PCT Filed: Sep. 14, 2022
(86) PCT No.: PCT/EP2022/075471

§ 371 Date: Feb. 13, 2024

(30) Foreign Application Priority Data
Oct. 13, 2021 (DE) 10 2021 126 497.9

(51) Int. Cl. H02K 9/22; H02K 1/16; H02K 5/04

(52) U.S. Cl. CPC H02K 9/22; H02K 1/16; H02K 5/04

(57) ABSTRACT

An assembly for an electric machine of a motor vehicle, comprising a stator, having a plurality of conductors, wherein at least one stator winding head of a winding formed from the conductors is embedded in a potting compound, comprising a housing which circumferentially surrounds at least the stator winding head, and comprising a heat-conducting device which is retained on the housing and has at least one spring element with regions thereof also being embedded in the potting compound for conducting heat from the stator winding head to the housing.

### BACKGROUND AND SUMMARY

The invention relates to an arrangement for an electric machine of a motor vehicle, to a method for providing an arrangement for an electric machine for a motor vehicle, and to a motor vehicle having an electric machine.

DE 10 2013 223 059 A1 discloses an electric machine comprising a rotor and a stator which surrounds the rotor and has multiple stator windings composed of electrical conductors. The electric machine also comprises a cylindrical housing surrounding the stator and two end windings. Each of the end windings is accommodated in an annular potting of an electrically insulating material, in which axial end regions of the stator windings at face ends of the stator are potted.

EP 2 113 991 B1 also discloses a laminated core of a stator of a dynamoelectric machine with windings arranged in grooves. The windings form end windings at the end faces of the laminated core, the end windings being embedded in a potting compound, in particular resin.

Thermal cooling of stator end windings is often a limiting factor for efficient operation of an electric machine. Therefore, use is made of what is referred to as a wet machine with oil cooling, which entails considerable technical outlay for outward sealing. What is referred to as full stator potting is thus considered for improving cooling and for making it possible to dispense with oil cooling.

The flow of current in the respective stator winding causes the winding to heat up. In what is referred to as the active part of the stator, heat generated in the winding can be discharged directly to a housing of the electric machine through a laminated core of the stator.

The end windings are not directly thermally coupled, and therefore they heat up to a considerably greater extent and often represent a limiting factor for cooling of the electric machine. In what are referred to as wet machines, the end windings are therefore cooled by being sprayed with oil; this is currently not possible in dry machines. A known thermal coupling to the housing is what is referred to as full stator potting. The different coefficients of thermal expansion of the end winding, which is made in particular of copper, of the full potting, which is made in particular of polymer, and a housing wall of the housing, which is made in particular of aluminum, produce stresses, which on the one hand can result in damage to the potted or adjacent components. Furthermore, cracks and gaps that can prevent a transfer of heat may be produced. Thus, cooling of the potting—during operation but also already during the production process—can lead to gap formation between the full potting and the housing, with the result that the transfer of heat is considerably impaired.

It is therefore an object of the present invention to provide a solution which enables particularly good cooling of stator end windings so that it is possible to dispense with oil cooling of an electric machine comprising these stator end windings.

This object is achieved according to the invention by the subject matter disclosed herein. Further possible embodiments of the invention are also disclosed in the description and the figures.

The invention relates to an arrangement for an electric machine of a motor vehicle, having a stator, which comprises a multiplicity of conductors. At least one stator end winding of a winding formed from the conductors is embedded in a potting compound. This potting compound may in particular be a polymer. The arrangement also comprises a housing, which circumferentially encloses at least one stator end winding. In particular, the housing may completely enclose the outside of the entire stator. The arrangement also comprises a heat conducting device, which is held on the housing and comprises at least one spring element, which is partially conjointly potted in the potting compound for transporting heat away from the stator end winding to the housing. The heat conducting device is thus fastened fixedly to the housing and enables tolerance compensation between the stator end winding, or the potting compound, and the housing by way of the elastic spring element. This allows the spring element to bridge gaps that arise between the housing and the potting compound as the potting compound cools. Consequently, a particularly reliable transfer of heat, which is independent of a gap size between the housing and the potting compound, from the stator end winding to the housing can be ensured. This enables particularly efficient cooling of the stator end winding and as a result particularly efficient operation of an electric machine comprising the arrangement. By virtue of the particularly good transfer of heat from the stator end winding to the housing via the heat conducting device, wet cooling of the electric machine with oil can be dispensed with. Consequently, the electric machine comprising the arrangement can be operated dry. This makes it possible for the electric machine to be provided particularly inexpensively and easily in structural terms.

One possible refinement of the invention provides that the heat conducting device comprises an outer ring held on the housing by an integral bond. This outer ring may enclose the stator end winding of the winding on the outside at least substantially around the entire circumference. A particularly large contact surface area between the heat conducting device and the housing can thus be provided via the outer ring, as a result of which the heat conducting device can be held particularly securely on the housing. Furthermore, the outer ring enables particularly precise positioning of the heat conducting device in relation to the housing and additionally relative to the stator end winding, owing to the enclosure of the stator end winding at least around the full circumference.

In this connection, a further possible embodiment of the invention may provide that the at least one spring element is stamped out of the outer ring. By stamping the spring element out of the outer ring, a particularly simple attachment of the at least one spring element to the outer ring and a particularly secure hold of the at least one spring element on the outer ring can be ensured. Furthermore, the heat conducting device can be provided with a particularly small amount of material and thus with a particularly low weight. Furthermore, by stamping out the at least one spring element on the outer ring, the spring element can be introduced into the heat conducting device particularly easily, since complex attachment of respective spring elements to the outer ring can be dispensed with.

Another possible embodiment of the invention provides that the at least one spring element is a leaf spring. The leaf spring has a structurally particularly simple construction and thus can be provided particularly easily and particularly robustly. A spacing between the potting compound and the housing can thus be bridged particularly reliably using the leaf spring as the at least one spring element.

Another possible embodiment of the invention provides that the heat conducting device and the housing comprise aluminum. This means that the heat conducting device and the housing are made of the same material, namely aluminum. This makes it possible to ensure a particularly good transfer of heat from the heat conducting device to the housing. Owing to the particularly good transfer of heat from the heat conducting device to the housing, the heat conducting device enables particularly good cooling of the stator end winding, this in turn enabling particularly efficient operation of the electric machine comprising the arrangement.

Another possible embodiment of the invention provides that the heat conducting device is pressed in the housing and/or welded to the housing. Consequently, a force fit and/or an integral bond can exist between the heat conducting device and the housing, as a result of which the heat conducting device can be held particularly securely and fixedly on the housing. Pressing the heat conducting device in the housing and welding it to the housing makes it possible to keep a risk of displacement or movement of the heat conducting device relative to the housing particularly low.

Another configuration of the invention provides that the heat conducting device comprises a multiplicity of spring elements. The provision of the multiplicity of spring elements makes it possible to be able to transport away a particularly large amount of heat from the stator end winding particularly quickly, as a result of which the stator end winding can be cooled particularly efficiently. In particular, the spring elements may be distributed at least substantially evenly around the inner circumference of the outer ring. In this respect, the spring elements can be arranged in particular at regular intervals on the outer ring, in particular on the inside of the outer ring, in order to enable even cooling of the stator end winding around the entire circumference of the stator. This enables particularly even cooling of the stator end winding by the multiplicity of spring elements, as a result of which local overheating of the stator end winding can be at least substantially avoided.

Another possible embodiment of the invention provides that the stator end winding is fully potted with the potting compound. Full potting is to be understood to mean that firstly the potting compound is formed cohesively and secondly all the conductors of a respective stator end winding of the stator are accommodated and thus potted in this cohesive potting compound. As a result, a relative positioning of the conductors in the respective stator end winding with respect to one another can be fixed by way of the potting compound. This makes it possible to be able to prevent undesired contact between respective conductors of the stator end winding. Furthermore, the full potting of the stator end winding makes it possible to be able to discharge the heat from the stator end winding particularly evenly around the entire circumference of the stator end winding, as a result of which the stator end winding in turn can be cooled particularly well. Furthermore, the full potting of the stator end winding makes it possible to protect the conductors against damage particularly well.

The invention also relates to a method for providing an arrangement for an electric machine of a motor vehicle. In particular, within the context of the method, the already-described arrangement according to the invention for the electric machine can be provided. The method provides that conductors in the form of a winding are introduced into a laminated core of the stator to mount the stator. It is also provided that a heat conducting device is fastened in a housing. Then, conductors of a stator end winding of the winding of the stator and at least one spring element of the heat conducting device are potted in a common potting compound. In the case of the arrangement, the potting compound and the conductors of the stator end winding are enclosed around the outer circumference by the heat conducting device at least in a longitudinal portion around their circumference. The method can thus provide that the stator end winding of the stator is potted with the potting compound, while the stator is mounted in the housing. This makes it possible to pot the stator end winding at least with the at least one spring element and possibly additionally with the housing, as a result of which a particularly good transfer of heat from the stator end winding to the housing can be ensured. Advantages and advantageous refinements of the arrangement according to the invention are to be considered advantages and advantageous refinements of the method according to the invention, and vice versa.

The invention also relates to a motor vehicle having an electric machine, which comprises the arrangement according to the invention or a refinement of the arrangement according to the invention and a rotor. The motor vehicle may in particular be designed to be operated by the electric machine. The motor vehicle may thus be an electric vehicle or a hybrid vehicle. By providing the arrangement according to the invention in the electric machine, the electric machine can be operated particularly efficiently, as a result of which the motor vehicle can be driven with a particularly high performance or a particularly low power consumption.

The claims, the figures and the description of the figures can yield further features of the invention. The features and combinations of features mentioned above in the description and the features and combinations of features shown below in the description of the figures and/or in the figures alone can be used not only in the respective specified combination but also in other combinations or individually without departing from the scope of the invention.

### BRIEF DESCRIPTION OF THE DRAWING

FIG. 1 shows a detail of an arrangement for an electric machine for a motor vehicle, having a stator, a housing surrounding the stator on the outer circumference at least in one longitudinal portion, and having a heat conducting device, which is designed to connect the stator to the housing, as a result of which heat can be discharged from the stator, in particular from a stator end winding of the stator, to the housing by way of the heat conducting device for particularly efficient cooling of the stator end winding.

### DETAILED DESCRIPTION OF THE DRAWING

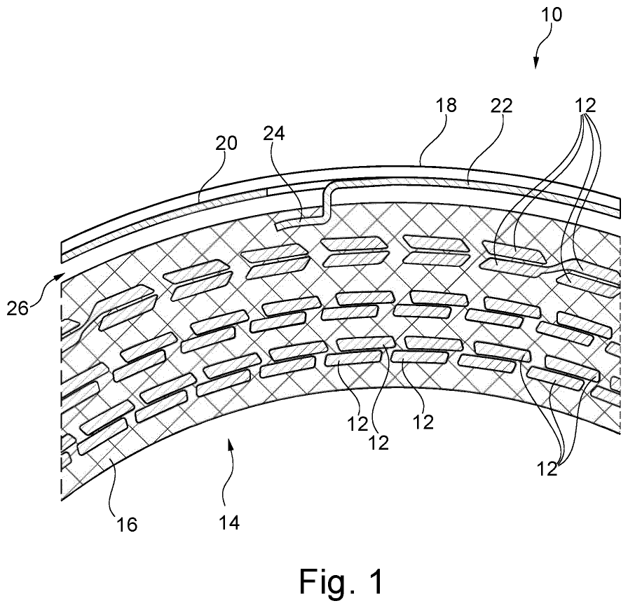

FIG. 1 shows a sectional view of a detail of an arrangement 10 for an electric machine for a motor vehicle. The electric machine can comprise, in addition to the arrangement 10 shown in FIG. 1, a rotor, which is not shown in FIG. 1 and can be rotated relative to the arrangement 10 about a center axis. In particular, the electric machine may be designed to be arranged in a motor vehicle, as a result of which the motor vehicle can be driven via electrical energy from the electric machine.

The arrangement 10 comprises a stator, which comprises a multiplicity of conductors 12. These conductors 12 form a winding, which can provide respective stator end windings 14 of the stator. These stator end windings 14 may be arranged on opposite sides of the stator. In the present case, a detail of only one of the stator end windings 14 is illustrated in FIG. 1. At least one of the stator end windings 14 is embedded in a potting compound 16, which is provided in particular by a polymer.

The arrangement 10 also comprises a housing 18, which radially encloses the outer circumference of at least the one stator end winding 14, in particular the stator, in one longitudinal portion. In the present case, this housing 18 is provided from aluminum. The arrangement 10 also comprises a heat conducting device 20, which is fixedly held on the housing 18. The heat conducting device 20 is likewise made of aluminum in the present case.

As can be seen particularly clearly in FIG. 1, the heat conducting device 20 comprises an outer ring 22, which is pressed in the housing 18 and/or welded to the housing 18. A spring element 24, stamped out of the outer ring 22, of the heat conducting device 20 can also be seen in FIG. 1. The heat conducting device 20 in particular comprises a multiplicity of spring elements 24, which may be distributed around the circumference of the outer ring 22. By stamping the at least one spring element 24 out of the outer ring 22, the spring element 24 is provided by a leaf spring in the present case. The at least one spring element 24 makes it possible to bridge a gap 26 that arises between the housing 18 and the potting compound 16 in the event of a change in volume of the potting compound 16, in particular owing to changes in temperature. This makes it possible to ensure a particularly efficient transfer of heat from the potting compound 16, or from the stator end windings 14 embedded in the potting compound 16, to the housing 18 via the heat conducting device 20.

As can be seen particularly clearly in FIG. 1, the stator end winding 14 in the present case is fully potted with the potting compound 16. Therefore, between the potting compound 16, which in particular provides potting of an end winding, and the housing 18, in particular a stator housing wall, there is at least one, in particular multiple, spring elements 24 designed to compensate movements between the potting compound 16 and the housing 18. This at least one spring element 24 is thermally conductive. The at least one spring element 24 is attached to the potting compound 16 and to the housing 18, in order to be able to ensure a transfer of heat from the potting compound 16 to the housing 18.

To provide the arrangement 10, conductors 12 may be introduced into a laminated core of the stator to mount the stator. Furthermore, the heat conducting device 20 may be fastened to the housing 18, which is arranged enclosing the outer circumference of the stator at least in one longitudinal portion. Then, the stator end winding 14 of the stator and the at least one spring element 24, in particular all the spring elements 24, of the heat conducting device 20 are potted in the common potting compound 16.

This means that, after the stator has been mounted, the outer ring 22 with the at least one spring element 24 is installed in the housing 18. When the stator is being potted, the spring elements 24 of the heat conducting device 20, which in the present case are in the form of a leaf spring, are conjointly potted into the potting compound 16. For this, the at least one spring element 24, in particular all the spring elements 24, of the heat conducting device 20 are guided up to the stator end winding 14 particularly closely.

By providing both the heat conducting device 20 and the housing 18 from aluminum, the housing 18 and the heat conducting device 20 have the same thermal expansion. A risk of gap formation between the heat conducting device 20 and the housing 18 can thus be kept particularly low.

Overall, the present disclosure shows how a spring ring for mechanically decoupling a full stator potting can be provided.

### LIST OF REFERENCE SIGNS

10 Arrangement
12 Conductor
14 Stator end winding
16 Potting compound
18 Housing
20 Heat conducting device
22 Outer ring
24 Spring element
26 Gap

1-10. (canceled)

11. An arrangement for an electric machine of a motor vehicle, comprising:
a stator, which comprises a plurality of conductors, wherein at least one stator end winding of a winding formed from the plurality of conductors is embedded in a potting compound;
a housing, which encloses an outer circumference of at least the stator end winding; and
a heat conducting device, which is held on the housing and comprises at least one spring element, which is partially conjointly potted in the potting compound and configured to transport heat away from the stator end winding to the housing.

12. The arrangement according to claim 11, wherein
the heat conducting device comprises an outer ring held on the housing by an integral bond.

13. The arrangement according to claim 12, wherein
the at least one spring element is stamped out of the outer ring.

14. The arrangement according to claim 11, wherein
the at least one spring element is a leaf spring.

15. The arrangement according to claim 11, wherein
the heat conducting device and the housing comprise aluminum.

16. The arrangement according to claim 11, wherein
the heat conducting device is pressed in the housing and/or welded to the housing.

17. The arrangement according to claim 11, wherein
the heat conducting device comprises a plurality of spring elements.

18. The arrangement according to claim 11, wherein
the stator end winding is fully potted with the potting compound.

19. A motor vehicle comprising:
an electric machine comprising:
the arrangement according to claim 11; and
a rotor.

20. A method for providing an arrangement for an electric machine of a motor vehicle, comprising:
introducing conductors in the form of a winding into a laminated core of a stator to mount the stator;
fastening a heat conducting device to a housing; and
potting at least one stator end winding of the winding of the stator and at least one spring element of the heat conducting device in a common potting compound.

21. The method according to claim 20, wherein
the heat conducting device comprises an outer ring held on the housing by an integral bond.

22. The method according to claim 21, comprising:
stamping the at least one spring element out of the outer ring.

23. The method according to claim 20, wherein
the at least one spring element is a leaf spring.

24. The method according to claim 20, wherein
the heat conducting device and the housing comprise aluminum.

25. The method according to claim 20, comprising:
pressing the heat conducting device in the housing, and/or welding the heat conducting device to the housing.

26. The method according to claim 20, wherein
the heat conducting device comprises a plurality of spring elements.

27. The method according to claim 20, comprising:
fully potting the stator end winding with the potting compound.
